(19) United States
(12) Patent Application Publication
(10) Pub. No.: US 2009/0326997 A1
(43) Pub. Date: Dec. 31, 2009

(54) MANAGING A COMPANY'S COMPLIANCE WITH MULTIPLE STANDARDS AND PERFORMING COST/BENEFIT ANALYSIS OF THE SAME

(75) Inventors: Jennifer G. Becker, New Hill, NC (US); Theodore F. Rivera, Raleigh, NC (US); Adam Tate, Raleigh, NC (US); Scott A. Will, Wake Forest, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/147,721

(22) Filed: Jun. 27, 2008

(51) Int. Cl. G06Q 10/00

(52) U.S. Cl. 705/7

(57) ABSTRACT

A set of internal processes of a business entity can be identified. At least one compliance standard can be selected. Each compliance standard can include a set of required processes for compliance. The internal processes can be programmatically compared against the set of required processes for the compliance standard. Differences between the internal processes and the required processes can be determined. A compliance cost can be estimated based at least in part upon the determined differences. An expected benefit of satisfying the compliance standard can be determined as can an expected return on investment. When compliance standards change, new compliance standards emerge, and/or business factors of the entity change, data used in previous runs can be re-used. Data concerning internal processes of the entity can be reused when determining compliance costs/benefits for a different standard.

### BACKGROUND OF THE INVENTION

The present invention relates to the field of software tools for business compliance management and more specifically to a system, method, software, and/or Web service for managing a company's compliance with multiple process standards and performing cost/benefit analysis of the same.

Numerous industry process standards exist, each having standard specific compliance requirements. For example, compliance requirements of International Organization for Standardization (ISO) 9000, GxP, Information Technology Infrastructure Library (ITIL), Six Sigma, Sarbanes-Oxley, and other standards can each require a company perform numerous internal processes and enact measures to prove its compliance. Complying with one or more of these standards requires companies to enact costly internal processes and to incur costs to maintain and prove their compliance. Compliance with each type of standard yields benefits, such as permitting a company to compete within an otherwise restricted market. Complicating matters, many restricted markets requiring compliance with a standard accept multiple standards. For example, a government entity that requires companies comply with a process standard (e.g., a quality assurance standard) before competing for a given work contract may accept bids from companies conforming to either an ISO standard or a Six Sigma standard.

At present, companies evaluate standard compliance decisions in an ad hoc fashion and/or through intense and manual evaluation efforts. For example, top level managers often engage “tiger teams” to evaluate their internal processes to determine a set of efforts needed to conform to a given standard. For each standard, a separate evaluation effort is conducted. Each of these evaluation efforts can be time intensive, costly, and can interrupt normal business processes. Results of these evaluations are often manually compared against a set of expectations of benefit to determine whether adjusting business processes to conform to a given standard is desired. Different evaluations can typically be performed for each of the different standards. Often experts focusing upon a given standard lack knowledge relating to other standards (i.e., a Six Sigma expert is often unaware of particulars of an ISO standard and vice versa).

The extent to which business processes are to be adjusted to ensure compliance with one or more standards can be a difficult decision, as conforming to many of the different standards requires different adjustments, which may have a variable set of common factors. For example, one set of process changes (Change A and Change B) may be required to conform to minimums of an ISO standard; another set of process changes (Change A and Change C) may be required to conform to minimums of a Six Sigma standard, still another set of changes (Change D, E, F) may be required to conform to minimums of an ITIL standard, etc. Different changes can result in different costs. Making a set of changes beyond a minimum set for a single standard, such as making a Change M, which includes changes needed to satisfy Change B and Change C, can be cost efficient.

The decision of whether to comply with a given standard is often based upon as much subjective data as objective. When new company leaders emerge, decisions change. Further, business standards are dynamic in that those standards preferred by companies can vary over time, as can requirements for a given standard. Companies conforming to multiple standards often have redundancies, one for each standard, which is inefficient compared to unifying common elements able to satisfy multiple standards. At present, no known tools exist that permit companies to evaluate costs versus benefit of compliance with a set of standards to help a company leverage work performed for compliance with one standard to achieve compliance with another, and to determine efficient change routes to adjust their processes to conform to one or more process standards.

### BRIEF SUMMARY OF THE INVENTION

One aspect of the present invention can include a method, computer program product, system, and device for managing compliance with a set of compliance standards. In this aspect, a set of internal processes of an entity (e.g., a corporation, organization, or other business entity) can be identified; at least one compliance standard (e.g., ISO, Six Sigma, ITIL, Sarbanes-Oxley, etc.) can be selected. Each compliance standard comprises a set of required processes for compliance. The internal processes can be programmatically compared against the set of required processes for the compliance standard. Multiple comparisons can be made for multiple different compliance standards and efficiencies can be calculated for concurrent compliance with multiple different standards at once. For example, adjusting internal processes to ensure multiple requirements of different standards are complied with can be more cost efficient than making discrete adjustments only considering the requirements of a single compliance standard. When comparing the internal processes against the requirements, differences between the internal processes and the required processes can be determined. A compliance cost can be estimated based at least in part upon the determined differences. An expected benefit of satisfying the compliance standard can be determined as can an expected return on investment. When compliance standards change, new compliance standards emerge, and/or business factors of the entity change, data used in previous runs can be re-used. For example, data concerning internal processes of the entity can be used originally for determining compliance costs/benefits for one standard, which can be reused when determining compliance costs/benefits for a different standard. In one embodiment of this aspect, a program/Web service that assists with compliance management can even suggest compliance standards for the business entity that yield a maximum return on investment (costs versus return) for that business entity. These suggested standards and changes need not be explicitly requested by a user. For example, the system can determine a high return on investment for compliance with a Six Sigma standard, and can notify a user of this possibility.

Another aspect of the invention can include a system for providing standard compliance support that includes a data store, programmatic instructions, and at least one computing device. The data store can include data specifying compliance standard requirements for a set of compliance standards and specifying business process data for a set of business entities. The business process data can include data for at least one of a business management process, at least one operational process of the associated business entity, and/or at least one support process of the associated business entity. The compliance standards can include one or more quality management standards, one or more regulatory standards, one or more environmental standards, one or more safety management standards, one or more reporting standards, and/or one or more electronic record standards. The programmatic instructions can be digitally encoded in a storage medium. The computing device can be communicatively linked to the data store and the storage medium. The computing device can execute the programmatic instructions. Execution of the programmatic instructions can cause the computing device to compare the specified business process data for one of the business entities against a set of the compliance standard requirements for multiple compliance standards; to determine a return on investment for ensuring the specified business processes of the business entity conform to each of the compliance standards; and to determine a cheapest path for adjusting the business processes to comply with each of the compliance standards.

### BRIEF DESCRIPTION OF THE SEVERAL VIEWS OF THE DRAWINGS

FIG. 1A is a schematic diagram of a system for compliance management that evaluates compliance of business processes against a multiple different standards in accordance with an embodiment of the inventive arrangements disclosed herein.

FIG. 1B is a schematic diagram showing a sample unified compliance management report in accordance with an embodiment of the inventive arrangements disclosed herein.

FIG. 2 illustrates a sample report able to be generated for a business entity by a compliance management system in accordance with an embodiment of the inventive arrangements disclosed herein.

FIG. 3 is a flow chart of a method for managing standard compliance for processes of one or more business entities against multiple standards in accordance with an embodiment of the inventive arrangements disclosed herein.

### DETAILED DESCRIPTION OF THE INVENTION

A solution for evaluating company processes in context with compliance requirements of one or more standards is described herein. In the solution, a company's data for their internal business processes can be programmatically defined. An information technology system can also include data elements associated with a set of different standard bodies. Deltas between the standards and the existing processes can be programmatically accessed and reports can be generated. For example, VENN DIAGRAMs and other reports can be constructed showing processes of a company compared to processes needed for compliance with the varying standards. In one embodiment, the reports can visually show overlaps, commonalities, and differences among the standards. Various factors can be computed relating to the deltas, such as calculating a cost versus expected return for compliance with one or more of the standards. Additionally, an efficient compliance path can be calculated, to assist a company in incrementally instituting a series of improvements that ultimately results in compliance with one or more of the different standards. Compliance cost/benefit calculations can be dynamically modified as changes to the standards and/or the marketplace occur. Further, as new standards emerge, these can be easily added to the solution, and costs/benefit analysis incorporating the newly added standards can be automatically performed. Importantly, the business data can be recorded once and re-used to the extent possible for determining compliance with multiple different standards.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

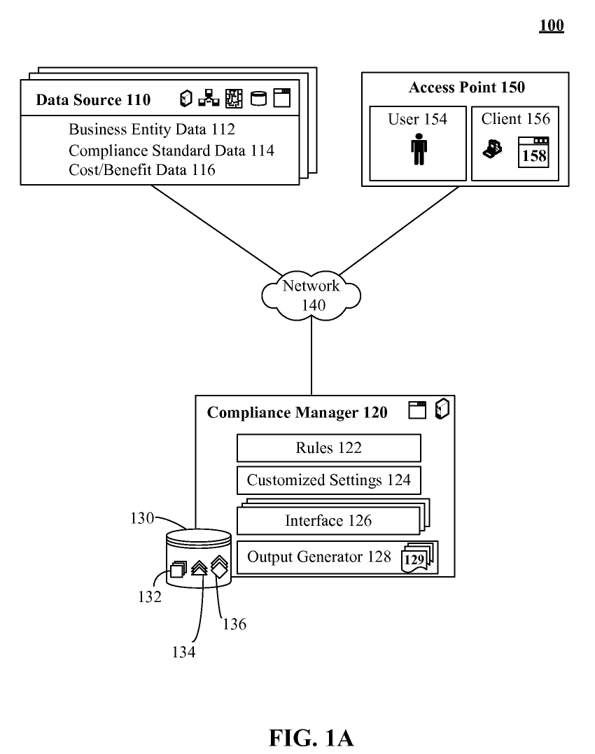

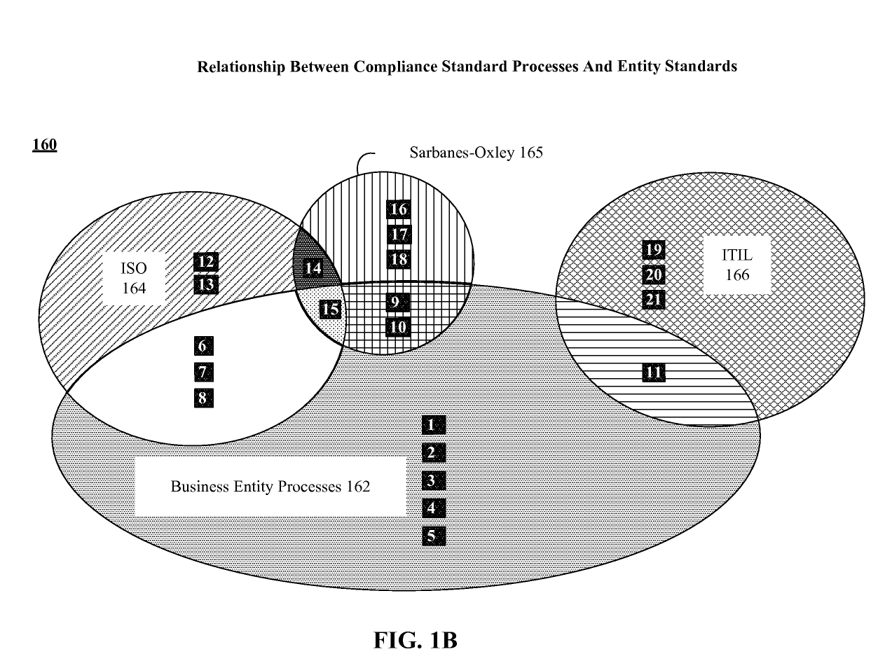

FIG. 1A is a schematic diagram of a system 100 for compliance management that evaluates compliance of business processes against multiple standards in accordance with an embodiment of the inventive arrangements disclosed herein. FIG. 1B is a schematic diagram showing a sample unified compliance management report in accordance with an embodiment of the inventive arrangements disclosed herein. That is, system 100 provides a mechanism (compliance manager 120) whereby effort required to obtain compliance with one standard can be beneficially leveraged when conducting subsequent compliance efforts for a different standard (or a different version of a standard). The compliance manager 120 can also analyze business entities against one or more compliance standards and estimate a return on investment for compliance and a most efficient compliance route.

In system 100, a compliance manager 120 can be communicatively linked to one or more data sources 110 and access points 150 through a network 140. The data sources 110 can provide business entity data 112, compliance standard data 114, cost/benefit data 116, and the like to the compliance manager 120. The compliance manager 120 can standardize the received data 112-116 and digitally store it within an accessible data store 130, which is a storage medium. In one embodiment, a set of application interfaces 126 (e.g., APIs), transcoding operations, reformatting operations, data reconciliation actions, and the like can be used to standardize the data acquired from the data sources 110 for use by compliance manager 120. The data from the source(s) 110 can be automatically updated with any desired frequency and through any of a variety of mechanisms. For example, system 100 can utilize polling methodologies, subscription methodologies, data mining methodologies, and the like to acquire and maintain a currency of stored data 132-136.

Stored data can include business process data 132 for one or more business entities, compliance standard requirements 134, and cost/benefit data 136. The compliance manager 120 can implement a set of rules 122 in accordance with customized settings 124 to generate business relative output 129 (via output generator 128) for compliance. The output 129 from generator 128 can produce data presentable within a user interface (e.g., interface of application 158), data that is placed in a data store for local processing, data that triggers previously established programmatic actions within an enterprise management system, and/or a set of reports. For simplicity of expression, all of these types of output are hereafter generically referred to as reports (129).

The reports 129 can identify differences and/or similarities between internal processes 162 of a business entity and requirements of one or more compliance standards 164-166. This can occur in an easy to view and understandable fashion, such as through a sample report 160, which is a VENN DIAGRAM showing existing processes of a business entity and their relationship between requirements of multiple compliance standards 164-166.

In the sample report 160, each process/requirement (labeled in FIG. 1B as small black boxes with white numerical text labels from one to twenty one) can be selected expanded upon. If the sample report 160 was presented within a graphical user interface, for example, placing a pointer over a given process/requirement could provide a pop-up showing details of related to that process/requirement. In a printed variation of sample report 160, the VENN DIAGRAM can be an overview, where subsequent report data elements provide relevant details. The VENN DIAGRAM is for illustrative purposes only as one means to provide an easy to view/comprehend overview of compliance/business process compatibility and system 100. The invention is not to be construed as limited in this regard, and other types of reports 129 are contemplated. For example, a tabular report 129 is contemplated that has columns for each internal process/requirement and has rows for each compliance standard, which is filled with values visually showing whether each internal process satisfies a given standard. In another example, a contemplated report 129 can be a bar graph showing two bars for each compliance standard. One of the two bars can represent satisfied requirements; the other bar can represent unfulfilled requirements. Each bar can be color coded or otherwise filled to depict different processes, thus the bars visually show which compliance requirements are satisfied by internal processes and which are not. In still another example, the report 129 can show pie charts for each compliance standard, each having regions specified for satisfied requirements, partially satisfied requirements, and unsatisfied requirements.

In one embodiment, one or more access points 150 remote from the contact manager 120 can be used to interact with the contact manager. An access point 150 can include one or more users 154 utilizing a client 156 having a client-side application 158. The application 158 can be any of a variety of software applications, such as a Web browser that renders a Web application.

In one embodiment, the compliance manager 120 can be implemented as one or more Web service, usable by client 156. A Web service can be a software component that permits clients 156 and servers 120 to communicate using extensible Markup Language (XML) messages that follow the SOAP standard. A Web service can be described via a Web service Description Language (WSDL). In one embodiment, compliance manager 120 can provide a set of one or more services configured to execute within a service oriented architecture (SOA).

Implementing the compliance functionality of manager 120 as a service, which is provided to business entities can be beneficial in many regards. For example, it can relieve individual business entities of the burden of maintaining currency with multiple different compliance standards, each of which can be enormously complex. It can also provide a standardized framework for recording internal business processes and related information in a fashion designed to be re-used across multiple different compliance standards. As these compliance standards are continuously evolving and can vary significantly from one another, maintaining an accurate and comprehensive database for multiple compliance standards can be expensive. Additionally, an entity (one that provides the services of manager 120) external to a business entity being evaluated for compliance can establish relatively unbiased costs/benefit analysis (data 136) for the evaluated entity, which can even be customized (settings 124) for entity specific goals/parameters. Appreciably, the effort to maintain an accurate set of cost/benefit data 136 alone can be a significant expense for a single business entity, but can be a cost spread across multiple entities when manager 120 is implemented as a business-entity-independent set of services.

It should be noted that the above embodiment, although advantageous in many circumstances, is not the only contemplated one. Another contemplated implantation of system 100 is a business-entity-specific implementation, such as integrating the compliance manager 120 within a business entity's enterprise management system. Further, hybrid systems can be implemented where a portion of the features shown for manager 120 are implemented within business-entity-specific systems and others are implemented in business-entity-independent systems. For example, the cost/benefit data 136 can be maintained by an independent entity (and provided to internal business entity specific IT systems as a Web service) while a majority of the components 122-128 of manager 120 are implemented within a business-entity-specific IT resource.

As used herein, a compliance standard can be a defined standard which establishes one or more requirements against which internal business processes are compared that can result in the business entity either being compliant or non-complaint with the standard. Compliance standards include, but are not limited to, a regulatory standard, a quality management standard, an environmental standard, a safety management standard, a financial reporting standard, a hiring standard, an electronic record standard, a manufacturing standard, and the like. Common compliance standards include ISO 9001, ITIL, Sarbanes Oakley, Six Sigma, FDA 21 CFR (Part 11 or part 820), and the like.

A business entity can represent any entity having a definable set of internal processes, which are capable of conforming to one or more compliance standards. Business entities can include individuals, businesses, corporations, non-profit organizations, for-profit organizations, and the like.

A business process (e.g., processes 162) can include any collection of interrelated tasks, which accomplish a definable goal. Business processes can include management processes, operational processes, and support processes. A management process can be one that governs an operation of a system, such as a corporate governance process, a strategic management process, and the like. An operational process can be a process that constitutes a core business of an entity and that creates a value stream. Operational processes can include purchasing processes, manufacturing processes, marketing processes, sales processes, etc. Supporting processes can include a set of processes which support the core processes, such as accounting processes, recruiting processes, IT support processes, human resource management processes, and the like. In one embodiment, business processes can be decomposed into several sub-processes, which have their own attributes, but also contribute to achieving the goal of the super-process. The business processes data 132 as stored in data store 130 can optionally conform to a variety of known modeling standards, such as a business processing modeling notation (BPMN) standard, Business Process Execution Language (BPEL), ebXML, etc.

Each data source 110 can include any set of hardware/software/firmware that is communicatively linked to the network 140 and from which business entity data 112, compliance standard data 114, and/or cost/benefit data 116 can be obtained. Data sources 110 are not limited to IT devices and can also include human resources capable of generating data 112-116 for use by the compliance manager 120. The data sources 110 can include URL addressable data sources, databases, private networks (such as a business's internal intranet), forecasting applications/systems, and the like.

Client 156 can be any computing device able to interact with compliance manager 120 via network 140. The client 156 can be a thin or a fat client. Client 156 can include a personal computer, a mobile telephone, a Web station, a kiosk, an intranet server able to interface with manager 120, and the like.

Compliance manager 120 can be a system of hardware/software/firmware that interacts to analyze processes of a business entity against a set of compliance standard requirements. The compliance manager 120 can include a distributed set of IT resources or can be implemented using non-distributed IT equipment. In one embodiment, at least a portion of the functionality of the compliance manager 120 can be implemented within middleware, such as within a WEBSPHERE based product. Further, novel features of the compliance manager 120 can be implemented as a plug-in, extension, or enhancement of an existing IT system. For example, an existing compliance software solution (e.g., IBM Solution for Compliance in a Regulated Environment (SCORE), an ISO 9000 based software solution, etc.) can be enhanced so that multiple compliance standards can be easily compared, so that business entity specific data can be reused across numerous different standards, and so that other currently non-existent features of system 100 are added to the existing solution.

Data store 130 can be a physical or virtual storage space configured to store digital information within a storage medium. The data stores 130 can be physically implemented within any type of hardware including, but not limited to, a magnetic disk, an optical disk, a semiconductor memory, a digitally encoded plastic memory, a holographic memory, or any other recording medium. Data store 130 can be a stand-alone storage unit as well as a storage unit formed from a plurality of physical devices. Additionally, information can be stored within data store 130 in a variety of manners. For example, information can be stored within a database structure or can be stored within one or more files of a file storage system, where each file may or may not be indexed for information searching purposes. Further, data store 130 can utilize one or more encryption mechanisms to protect stored information from unauthorized access.

Network 140 can include any hardware, software, and/or firmware necessary to convey data encoded within carrier waves. Data can be contained within analog or digital signals and conveyed through data or voice channels. Network 140 can include local components and data pathways necessary for communications to be exchanged among computing device components and between integrated device components and peripheral devices. Network 140 can also include network equipment, such as routers, data lines, hubs, and intermediary servers which together form a data network, such as the Internet. Network 140 can also include circuit-based communication components and mobile communication components, such as telephony switches, modems, cellular communication towers, and the like. Network 140 can include line based and/or wireless communication pathways.

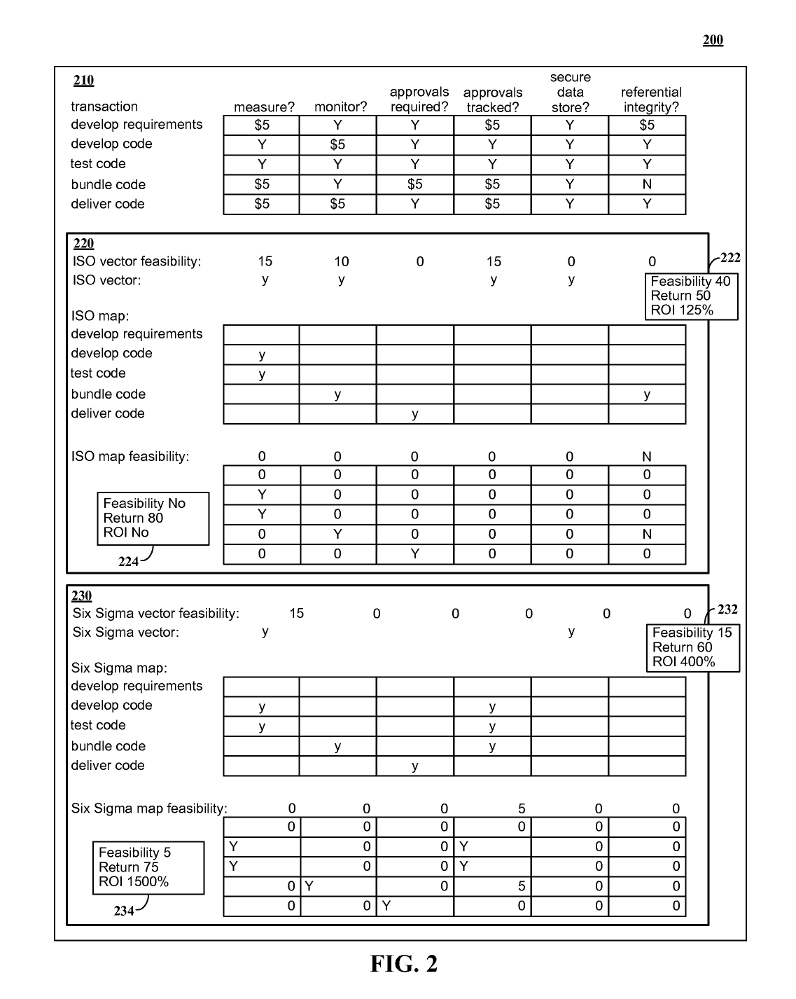

FIG. 2 illustrates a sample report 200 able to be generated for a business entity by a compliance management system in accordance with an embodiment of the inventive arrangements disclosed herein. In one embodiment, the report 200 can be one of the reports 129 shown in FIG. 1.

The report 200 demonstrates a simple certification analysis for the same business process. Report 200 permits a user of a system that generated the report 200 to determine the feasibility, ease of compliance, and overall return of investment to make information decisions about applying for certification or updating existing business processes to maintain certification.

In section 210 of the report 200 an existing business process can be decomposed into sub-processes to develop requirements, develop code, test code, bundle code, and deliver code. Each of these sub-processes can have recorded values for measuring, monitoring, requiring approval, tracking approval, securing data, and enforcing referential integrity.

In section 220, the existing business process of section 210 can be evaluated against an ISO standard. An ISO vector feasibility score of forty can be reported, as can a return score of fifty and a return on investment of one hundred and twenty five percent, as shown by totals 222. An ISO map feasibility score was not possible, a return value was calculated at a score of eighty and the return on investment percentage could not be calculated, as shown by totals 224.

In section 230, the existing business process of section 210 can be evaluated against a Six Sigma standard. A Six Sigma vector feasibility score of fifteen can be reported, along with a return score of sixty, and a return on investment of four hundred, as shown by totals 232. A Six Sigma map feasibility score of five, a return score of seventy five, and a return on investment of one thousand five hundred can be reported in totals 234.

It should be appreciated that the report 200 represents just one sample report and that the invention is not to be limited in this regard. For example, it is completed that reports can be generated where higher cost processes are designated and identified for reuse across standards bodies. In another example, a category of keeping confidential material can be included along with an associated cost. Reports can highlight conflicts among different compliance standards, which can make it difficult or impossible to concurrently comply with these conflicting requirements. For example, one standard can require business material be kept confidential and handled in a specific fashion, where another standard requires an overlap of the business material to be kept non-confidentially in a specified manner. Regardless of the specific, the report 200 or variations of it are driven by a knowledge base of tasks (business processes), certification requirements (for one or more compliance standard), a level of work involved (costs), and benefit to be received.

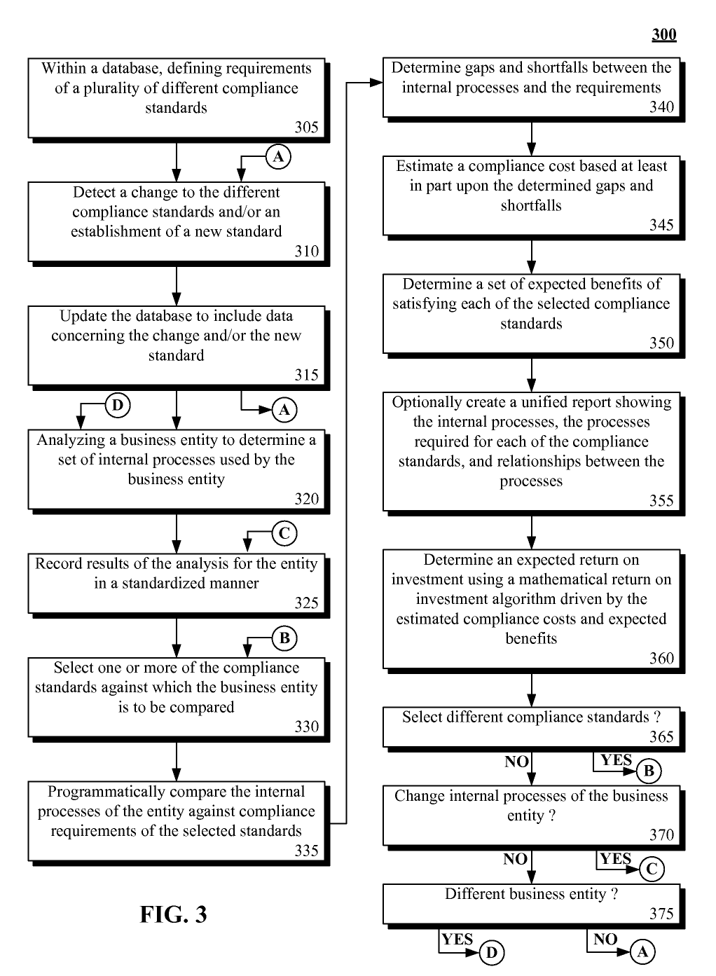

FIG. 3 is a flow chart of a method 300 for managing standard compliance for processes of one or more business entities against multiple standards in accordance with an embodiment of the inventive arrangements disclosed herein. The method 300 can be performed in context of system 100.

Method 300 can begin in step 305, where requirements of a set of one or more compliance standards can be defined. Currency of data for these standards can be maintained, as expressed by steps 310 and 315. In step 310, a change in a previously stored compliance standard and/or an establishment of a new compliance standard can be detected. In step 315, the database can be updated to include data concerning the change and/or the new standard. Multiple different versions of a similar standard can be maintained within the database. It is possible for a business entity to conform to requirements of one version of a compliance standard, such as a non-current version, while failing to meet the requirements for a different version of the same standard. Successfully meeting requirements of an older version of a standard may still yield a significant benefit to a business entity depending upon the standard. For example, many companies may permit a company complying with an older (non-current) version of a quality assurance standard to compete on a bid for work, while others may require compliance with a most current version of a given quality assurance standard. In another example, compliance with a non-current version of a standard can have little value, such as compliance with an older version of the Sarbanes-Oxley Act (assuming no grandfather provisions are included in an updated Act). The method 300 shows a looping from step 315 to step 310, which reflects that the database is repetitively updated with current data.

In step 320, a business entity can be analyzed to determine a set of internal processes used by the business entity. This analysis can be manual, can be partially automated, or can be fully automated. For example, a “tiger team” can evaluate a business's processes in a largely manual effort to determine internal processes. In another example, internal processes of a business can be institutionalized and monitored by enterprise level software management solutions, from which business process data can be extracted. In step 325, results of the analysis can be recorded for the entity in a standardized manner. The manner of recordation can be intended to permit the business process data to be utilized and/or compared against a plurality of different compliance standards.

In step 330, one or more of the compliance standards can be selected against which the business entity is to be compared. In step 335, the internal processes of the business entity can be programmatically compared against the compliance requirements of the selected standards. In step 340, differences and/or similarities between compliance requirements and internal processes can be determined based upon comparison results. In step 345, compliance costs can be estimated based upon the determined differences. In step 350, a set of expected benefits of satisfying the compliance standards can be determined.

During steps 330-350 comparisons can be performed on a one-to-one basis between the business entity and selected compliance standard and/or the business entities processes can be compared against a group of two or more compliance standards. For example, instead of just defining a gap between a business entity's process and a first standard and a different gap between the processes and a second standard, a gap can be determined between the business entity's processes and a group of standards including the first and second standard. Assuming there is a level of overlap between standard requirements, the grouping can result in different analysis results (different combinative benefits, costs, return on investment values, etc.) than discrete analysis based solely on a one to one correspondence between business entity processes and compliance requirements.

In step 355, an optional set of one or more reports can be created. These reports can show internal processes, processes required for each compliance standard, and relationships between the processes. The report can be created at various granularity levels, which can include a by process break-down and a set of processes specific enhancements needed for compliance with various standards and/or sets of standards. In one embodiment, a unified report can be created that permits a user to view relationships among existing processes and multiple standards, which includes a set of needed enhancements for compliance with these standards. Sample report 160 of FIG. 1 is an example of one such report.

In step 360, an expected return on investment can be determined using a mathematical return on investment algorithm driven by estimated compliance costs and expected benefits. Additionally a cheapest/quickest/most efficient path can be determined to alter existing processes to meet one or more compliance standards.

In step 365, the method can loop back to step 330 should a user desire to analyze their business processes against a different set of compliance standards. In step 370, the method can loop back to step 325, should internal processes of a business entity change; in which case the analysis can be redone in light of these changes. If a different business entity is to be analyzed, the method can proceed from step 375 to step 320, where the different business entity can be analyzed to determine a set of internal processes that the new entity utilizes. Otherwise, the method can proceed from step 375 to step 310, where the method can be driven by changes in compliance standards. In one embodiment, when these compliance standards change, new runs comparing business entities to the changed standards can be automatically performed and the business entities can be automatically proved reports detailing how their internal process compares to the changes in the compliance standards. In another embodiment, business entities can be notified when changes to compliance standards, which may affect that business entity occur, which enables administrators from those business entities to take actions deemed appropriate (i.e., the administrators can either perform analysis against the new standards or not).

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing compliance with at least one compliance standard comprising:
identifying at least one internal process of an entity;
identifying at least one compliance standard, wherein each compliance standard comprises at least one required process;
programmatically comparing said at least one internal process against said at least one required processes for the compliance standard;
determining differences between said at least one internal process and said at least one required process;
estimating a compliance cost based at least in part upon the determined differences; and
ascertaining an expected benefit of satisfying the compliance standard.

2. The method of claim 1, wherein said at least one internal process comprises a plurality of internal processes of the entity, wherein said at least one compliance standard comprises a plurality of compliance standards, and wherein said at least one required process comprises a plurality of required processes.

3. The method of claim 1, further comprising:
determining an expected return on investment using a return on investment algorithm driven by the estimated compliance cost and the ascertained expected benefit.

4. The method of claim 1, further comprising:
determining a maintenance cost for processes to be performed by the entity to maintain compliance with the compliance standard; and
estimating the compliance cost based upon the determined differences, and the maintenance cost.

5. The method of claim 1, wherein the at least one compliance standard comprises a plurality of compliance standards, said method further comprising:
creating a unified report showing said at least one internal processes, said at least one required process for each of the compliance standards, and relationships among said at least one internal process and said at least one required process.

6. The method of claim 5, wherein the unified report comprises a VENN DIAGRAM showing a region for each of the compliance standards and a region for the entity, wherein said region for said entity visually depicts said at least one internal process, and each region for each compliance standard visually depicts said at least one requirement associated with that compliance standard or visually depicts an internal process corresponding to a requirement of the compliance standard, and wherein overlaps among the compliance standards and the internal processes are shown in overlapping regions of the VENN DIAGRAM.

7. The method of claim 1, wherein the at least one compliance standard comprises a plurality of compliance standards, said method further comprising:
identifying said at least one internal process and a modification to said at least one internal processes able to satisfy said at least one requirement for multiple ones of the compliance standards;
determining cost savings achieved by establishing said modification able to satisfy requirements of multiple compliance standards; and
estimating compliance costs, expected benefit, and return on investment values for compliance with discrete ones of the compliance standards and for compliance with groups of different compliance standards taking the determined cost savings into account when calculating values for the groups.

8. The method of claim 1, said method further comprising:
determining a cheapest path and a greatest return on investment for modifying said at least one internal process to conform with said compliance standards.

9. The method of claim 1, wherein the at least one compliance standard comprises a plurality of compliance standards, said method further comprising:
reusing said at least one internal process and effort taken to maintain compliance with one of the compliance standards when estimating a compliance cost, an expected benefit, and a return on investment for a different one of the compliance standards, wherein said compliance standards comprise at least two of a quality management standard, a regularity standard, an environmental standard, a safety management standard, a reporting standard, and an electronic record standard.

10. The method of claim 1, further comprising:
implementing a compliance system within a network element, which supports a plurality of different entities, said plurality of different entities comprising said entity;
maintaining currency of data for a plurality of different compliance standards within a database accessible by the compliance system; and
interfacing the compliance system with management information systems of each of the different entities to obtain entity specific information used for at least one of identifying said at least one internal process of the related entity, estimating compliance costs for the entity, ascertaining the expected benefit for the entity, and determining the expected return on investment for the entity, wherein a plurality of software implemented tools and programmatic capabilities of the compliance system are utilized to assist in identifying the plurality of internal processes, in selecting the at least one compliance standard, in programmatically comparing the internal processes against the required processes, in determining differences, in estimating the compliance cost, in ascertaining the expected benefit, and in determining the expected return on investment.

11. The method of claim 1, wherein said internal processes comprise at least one business management process, at least one operational process, and at least one support process.

12. A computer program product for managing compliance with at least one compliance standard comprising:
a computer usable medium having computer usable program code embodied therewith, the computer usable program code comprising:
computer usable program code configured to identify at least one internal process of an entity;
computer usable program code configured to identify at least one compliance standard, wherein each compliance standard comprises at least one required process;
computer usable program code configured to programmatically compare said at least one internal process against said at least one required processes for the compliance standard;
computer usable program code configured to determine differences between said at least one internal process and said at least one required process;
computer usable program code configured to estimate a compliance cost based at least in part upon the determined differences; and
computer usable program code configured to ascertain an expected benefit of satisfying the compliance standard.

13. The computer program product of claim 12, wherein said at least one internal process comprises a plurality of internal processes of the entity, wherein said at least one compliance standard comprises a plurality of compliance standards, and wherein said at least one required process comprises a plurality of required processes.

14. The computer program product of claim 12, further comprising:
computer usable program code configured to determine an expected return on investment using a return on investment algorithm driven by the estimated compliance cost and the ascertained expected benefit.

15. The computer program product of claim 12, wherein the at least one compliance standard comprises a plurality of compliance standards, said computer usable program code further comprising:
computer usable program code configured to create a unified report showing said at least one internal processes, said at least one required process for each of the compliance standards, and relationships among said at least one internal process and said at least one required process.

16. The computer program product of claim 15, wherein the unified report comprises a VENN DIAGRAM showing a region for each of the compliance standards and a region for the entity, wherein said region for said entity visually depicts said at least one internal process, and each region for each compliance standard visually depicts said at least one requirement associated with that compliance standard or visually depicts an internal process corresponding to a requirement of the compliance standard, and wherein overlaps among the compliance standards and the internal processes are shown in overlapping regions of the VENN DIAGRAM.

17. The computer program product of claim 12, wherein the at least one compliance standard comprises a plurality of compliance standards, said computer usable program code further comprising:
computer usable program code configured to identify said at least one internal process and a modification to said at least one internal processes able to satisfy said at least one requirement for multiple ones of the compliance standards;
computer usable program code configured to determine cost savings achieved by establishing said modification able to satisfy requirements of multiple compliance standards; and
computer usable program code configured to estimate compliance costs, expected benefit, and return on investment values for compliance with discrete ones of the compliance standards and for compliance with groups of different compliance standards taking the determined cost savings into account when calculating values for the groups.

18. The computer program product of claim 12, further comprising:
computer usable program code configured to implement a compliance system within a network element, which supports a plurality of different entities, said plurality of different entities comprising said entity;
computer usable program code configured to maintain currency of data for a plurality of different compliance standards within a database accessible by the compliance system; and
computer usable program code configured to interface the compliance system with management information systems of each of the different entities to obtain entity specific information used for at least one of identifying said at least one internal process of the related entity, estimating compliance costs for the entity, ascertaining the expected benefit for the entity, and determining the expected return on investment for the entity, wherein a plurality of software implemented tools and programmatic capabilities of the compliance system are utilized to assist in identifying the plurality of internal processes, in selecting the at least one compliance standard, in programmatically comparing the internal processes against the required processes, in determining differences, in estimating the compliance cost, in ascertaining the expected benefit, and in determining the expected return on investment.

19. A system for providing standard compliance support comprising:
a data store comprising data specifying compliance standard requirements for a plurality of compliance standards and specifying business process data for a plurality of business entities, wherein said business process data comprises data for at least one of a business management process, at least one operational process of the associated business entity, and at least one support process of the associated business entity, and wherein said compliance standards comprise at least two of a quality management standard, a regulatory standard, an environmental standard, a safety management standard, a reporting standard, and an electronic record standard;
programmatic instructions digitally encoded in a storage medium; and
at least one computing device communicatively linked to the data store and the storage medium, wherein said computing device is configured to execute said programmatic instructions, wherein execution of said programmatic instructions causes said computing device to compare the specified business process data for one of the business entities against a plurality of the compliance standard requirements for at least two of the compliance standards; to determine a return on investment for ensuring the specified business processes of the business entity conform to each of the at least two compliance standards; and to determining a cheapest path for adjusting the business processes to comply with each of the compliance standards.

20. The system of claim 19, wherein the computing device is a Web service server, wherein the programmatic instructions are instructions of a Web service provided by the Web service server to a plurality of remotely located computing devices, each of which is communicatively linked to said network.

21. The system of claim 19, wherein the execution of the programmatic instructions causes said computing device to dynamically update said compliance standard requirements as changes occur to said compliance standards, to reuse a common set and a standardized format of the business process data for a plurality of different compliance standards, and to suggest ones of the compliance standards for which an estimated return on investment is above a specified threshold even when a user associated with the business entity for which the return on investment is estimated has not explicitly specified that an analysis is to be conducted for the suggested ones of the compliance standards.

22. The system of claim 20, wherein the execution of the programmatic instructions causes said computing device to create a unified report showing the business processes for a business entity, compliance standard requirements of the at least two compliance standards, and relationships among the business processes and the compliance standard requirements.

23. The system of claim 22, wherein the unified report comprises a VENN DIAGRAM configured to show a region for each of the compliance standards and a region for the entity, wherein said region for said entity visually depicts at least one business process, and each said region for each compliance standard visually depicts at least one requirement associated with that compliance standard or visually depicts a business process corresponding to a requirement of the compliance standard, and wherein overlaps among the compliance standards and the internal processes are shown in overlapping regions of the VENN DIAGRAM.
